(19) United States
(12) Patent Application Publication
(10) Pub. No.: US 2023/0306075 A1
(43) Pub. Date: Sep. 28, 2023

(54) COMPUTER-READABLE RECORDING MEDIUM STORING CALCULATION PROGRAM AND CALCULATION METHOD

(71) Applicant: Fujitsu Limited, Kawasaki-shi (JP)

(72) Inventor: Yosuke OYAMA, Kawasaki (JP)

(73) Assignee: Fujitsu Limited, Kawasaki-shi (JP)

(21) Appl. No.: 18/068,122

(22) Filed: Dec. 19, 2022

(30) Foreign Application Priority Data
Mar. 24, 2022 (JP) 2022-049092

(51) Int. Cl. G06F 17/12

(52) U.S. Cl. CPC G06F 17/12

(57) ABSTRACT

A non-transitory computer-readable recording medium stores a calculation program for causing a computer to execute a process including: executing calculation of an iterative method for iterating update of a solution by using a plurality of processing circuits operating in parallel in one or each of a plurality of loop processing; executing the calculation of the iterative method by using the plurality of processing circuits in predetermined loop processing after the one or plurality of loop processing; and determining a timing of determination processing of determining update end in the calculation of the iterative method of the predetermined loop processing based on a number of times the solution is updated in the calculation of the iterative method of the one or each of the plurality of loop processing, wherein the determination processing includes processing of determining the update end based on a result of communication between the plurality of processing circuits.

### CROSS-REFERENCE TO RELATED APPLICATION

This application is based upon and claims the benefit of priority of the prior Japanese Patent Application No. 2022-49092, filed on Mar. 24, 2022, the entire contents of which are incorporated herein by reference.

### FIELD

The embodiment discussed herein is related to a calculation technique.

### BACKGROUND

As an iterative method for obtaining a solution of a symmetric system of linear equations, a conjugate gradient method (CG method) and a preconditioned conjugate gradient method (preconditioned CG method or PCG method) have been known. As an iterative method for obtaining a solution of an asymmetric system of linear equations, a biconjugate gradient method (BiCG method) and a preconditioned BiCG method (PBiCG method) have been also known.

Japanese Laid-open Patent Publication Nos. 2007-287055 and 2017-97392, and U.S. Patent Application Publication No. 2010/0293213 are disclosed as related art.

E. F. Kaasschieter, “Preconditioned conjugate gradients for solving singular systems”, Journal of Computational and Applied Mathematics, Vol. 24, pages 265-275, 1988; and “Biconjugate Gradient Method”, Wolfram MathWorld, Sep. 19, 2021, [online], [searched on Oct. 1, 2021], Internet <URL:https://mathworld.wolfram.com/BiconjugateGradientMethod.html> are also disclosed as related art.

### SUMMARY

According to an aspect of the embodiments, a non-transitory computer-readable recording medium stores a calculation program for causing a computer to execute a process including: executing calculation of an iterative method for iterating update of a solution by using a plurality of processing circuits operating in parallel in one or each of a plurality of loop processing; executing the calculation of the iterative method by using the plurality of processing circuits in predetermined loop processing after the one or plurality of loop processing; and determining a timing of determination processing of determining update end in the calculation of the iterative method of the predetermined loop processing based on a number of times the solution is updated in the calculation of the iterative method of the one or each of the plurality of loop processing, wherein the determination processing includes processing of determining the update end based on a result of communication between the plurality of processing circuits.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a pseudo code of a CG method;

FIG. 2 is a diagram illustrating a pseudo code of a PCG method;

FIG. 3 is a diagram illustrating a pseudo code of a PBiCG method;

FIG. 4 is a diagram illustrating a first pseudo code of a parallelized CG method;

FIG. 5 is a diagram illustrating a pseudo code of gSumProd;

FIG. 6 is a diagram illustrating a pseudo code of gSpMV;

FIG. 7 is a diagram illustrating a pseudo code of gSumMag;

FIG. 8 is a diagram illustrating a second pseudo code of the parallelized CG method;

FIG. 9 is a functional configuration diagram of an information processing apparatus according to an embodiment;

FIG. 10 is a flowchart of first calculation processing;

FIG. 11 is a functional configuration diagram illustrating a specific example of the information processing apparatus;

FIG. 12 is a diagram illustrating the pseudo code of the CG method in which the number of times of determination processing is adjustable;

FIG. 13 is a diagram illustrating a change in min(sⱼ);

FIG. 14 is a diagram illustrating a first operation in loop processing;

FIG. 15 is a diagram illustrating a second operation in the loop processing;

FIG. 16 is a diagram illustrating a third operation in the loop processing;

FIGS. 17A to 17C are diagrams illustrating the number of times of calculation of a residual norm;

FIG. 18 is a flowchart of second calculation processing;

FIG. 19 is a flowchart of solution update processing;

FIG. 20 is a flowchart of history update processing;

FIG. 21 is a diagram illustrating solution update processing;

FIG. 22 is a hardware configuration diagram of the information processing apparatus including a plurality of nodes;

FIG. 23 is a diagram illustrating a calculation time in a fluid analysis simulation;

FIGS. 24A and 24B are diagrams illustrating the number of times of calculation for δᵢ and the number of times of solution update in the fluid analysis simulation; and

FIG. 25 is a hardware configuration diagram of the information processing apparatus.

### DESCRIPTION OF EMBODIMENTS

An analysis apparatus that may acquire information such as convergence determination of a numerical analysis operation and the number of times of calculation until convergence during calculation has been also known. An iterative calculation amount estimation apparatus that estimates a calculation amount up to completion of calculation with higher accuracy in iterative calculation has been also known. A method for approximating a function has been also known.

When the calculation of the iterative method for obtaining the solution of the system of linear equations is parallelized by using a plurality of processes, a time taken for inter-process communication may be a bottleneck.

Such a problem occurs not only when the calculation of the iterative method is parallelized by using the plurality of processes but also when the calculation of the iterative method is parallelized by using various processing units.

According to one aspect, an object of the present disclosure is to shorten a calculation time of an iterative method using a plurality of processing units that operate in parallel.

Hereinafter, an embodiment will be described in detail with reference to the drawings.

First, a solution of a system of linear equations as in the following equation will be described.

Ax=b (1)

A matrix A represents a coefficient matrix, and a vector b represents a constant term. A vector x represents a solution of a system of linear equations. For example, a sparse matrix is used as A.

When A is a symmetric matrix, Equation (1) is a symmetric system of linear equations, and when A is an asymmetric matrix, Equation (1) is an asymmetric system of linear equations. For example, a CG method or a PCG method is used as an iterative method of a symmetric system of linear equations, and for example, a BiCG method or a PBiCG method is used as the iterative method of the asymmetric system of linear equations.

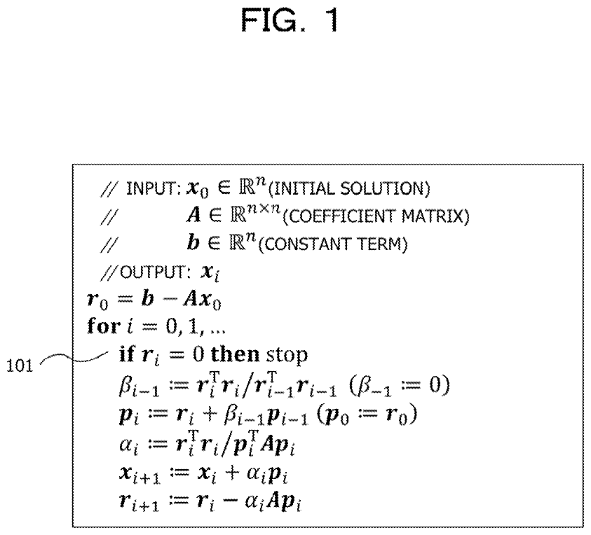

FIG. 1 illustrates an example of a pseudo code of the CG method. A vector xᵢ represents a solution updated in the iterative method, and a vector x₀ represents an initial solution. A vector rᵢ represents a residual updated in the iterative method, and a vector r₀ represents an initial residual.

rᵢ=0 in an if-statement 101 represents an end condition of a for-loop in the CG method. Practically, when a norm of rᵢ becomes smaller than an appropriate threshold ε, the calculation of the iterative method is terminated, and xᵢ calculated last is output as a solution.

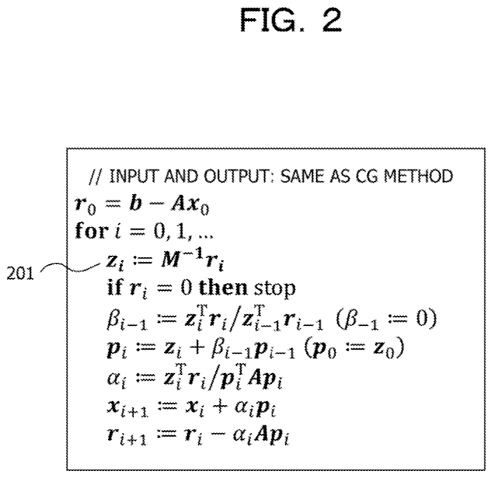

FIG. 2 illustrates an example of a pseudo code of the PCG method described in E. F. Kaasschieter, “Preconditioned conjugate gradients for solving singular systems”, Journal of Computational and Applied Mathematics, Vol. 24, pages 265-275, 1988. M in Equation 201 represents a preconditioner, and M⁻¹ represents an inverse matrix of M. Equation 201 represents preconditioning of calculating a sparse matrix-vector multiplication of M⁻¹ and rᵢ in the PCG method. According to the PCG method, the convergence of a solution is improved by applying preconditioning to rᵢ.

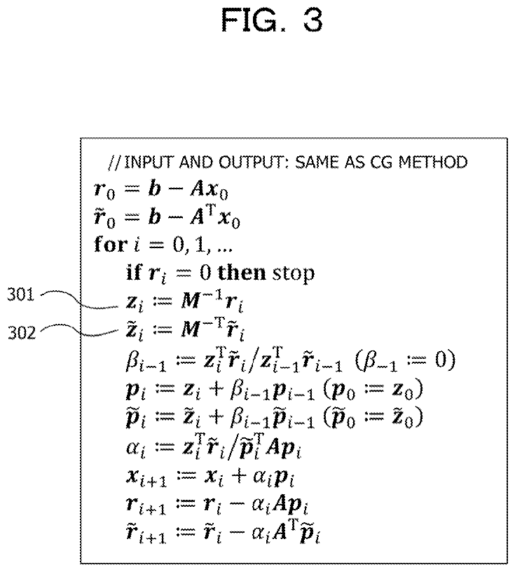

FIG. 3 illustrates an example of a pseudo code of the PBiCG method. Equation 301 corresponds to Equation 201 in FIG. 2. M^{-T} in Equation 302 represents a transposed matrix of M⁻¹. M^{-T} matches an inverse matrix of the transposed matrix M^{T} of M. Equation 301 and Equation 302 represent preconditioning in the PBiCG method.

When the matrix A is a symmetric matrix, an algorithm of the PBiCG method matches an algorithm of the PCG method. When the preconditioning is not applied, M⁻¹ is a unit matrix, and the algorithm of the PBiCG method matches an algorithm of the BiCG method.

When the calculation of the iterative method is parallelized by using a plurality of processes, a variable is divided into a plurality of parts, and calculation using each part is allocated to each process.

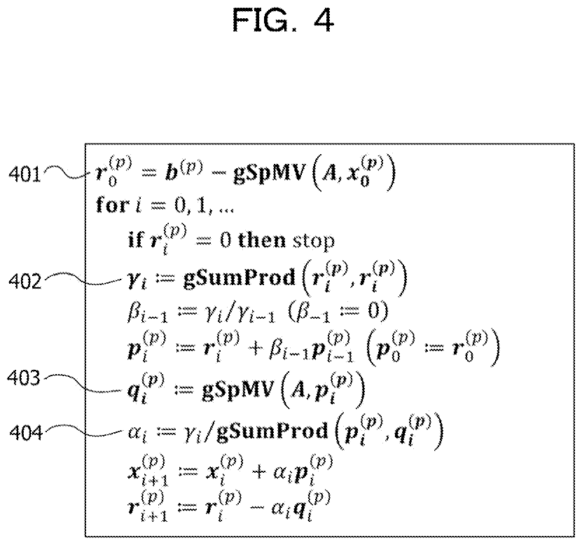

FIG. 4 illustrates an example of a first pseudo code of the parallelized CG method. A vector x^{(p)} represents a vector updated by a process p among divided vectors x. For example, the number of elements of x is equally divided by the number of processes, and elements of parts are sequentially allocated to processes p, respectively. A vector r^{(p)} represents a vector updated by the process p among divided vectors r. x^{(p)} is an example of a part of the solution of the system of linear equations, and r^{(p)} is an example of a residual for the part of the solution.

Equation 401 is a calculation equation for obtaining r₀^{(p)} allocated to the process p. gSpMV(A, x₀^{(p)}) in Equation 401 represents a part used by the process p among elements of a vector representing a matrix-vector multiplication of A and x₀. gSpMV(A, pᵢ^{(p)}) in Equation 403 represents a part used by the process p among elements of a vector representing a matrix-vector multiplication of A and pᵢ.

gSumProd (rᵢ^{(p)}, rᵢ^{(p)}) in Equation 402 represents an inner product of the vector rᵢ and the vector rᵢ. gSumProd (pᵢ^{(p)}, qᵢ^{(p)}) in Equation 404 represents an inner product of the vector pᵢ and the vector qᵢ.

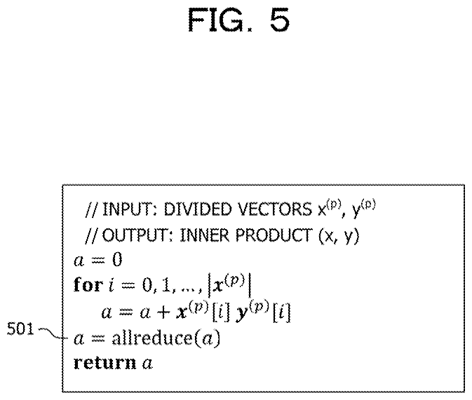

FIG. 5 illustrates an example of the pseudo code in gSumProd in FIG. 4. A pseudo code in FIG. 5 outputs an inner product (x, y) of the vector x and the vector y, which is calculated by using the divided vector x^{(p)} and the divided vector y^{(p)}.

allreduce(a) in Equation 501 corresponds to allreduce of a message passing interface (MPI), and represents a total sum of values of a calculated by each process p. allreduce communication is an example of collective communication. Collective communication is one-to-many, many-to-one, or many-to-many communication performed between a plurality of communication entities such as processes.

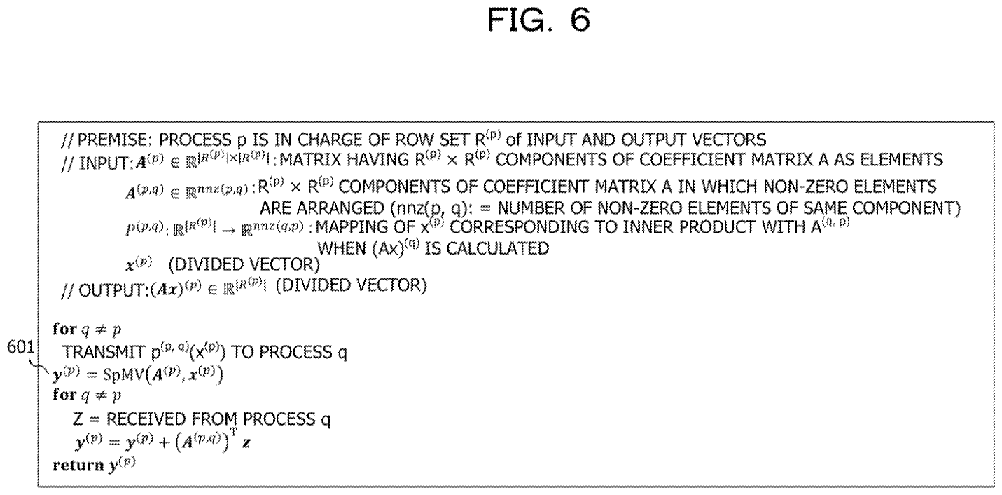

FIG. 6 illustrates an example of the pseudo code in gSpMV in FIG. 4. A pseudo code in FIG. 6 outputs y^{(p)}=(Ax)^{(p)} which is a part used by the process p among elements of a vector representing a matrix-vector multiplication of A and x.

A row set R^{(p)} represents a set of row numbers of elements handled by the process p among elements of column vectors representing input and output. A matrix A^{(p)} represents a matrix having R^{(p)}×R^{(p)} components of A as elements. Among the elements of A, the R^{(p)}×R^{(p)} components represent the elements of A corresponding to the rows indicated by the numbers of R^{(p)} and the columns indicated by the numbers of R^{(p)}.

A^{(p, q)} represents a vector including non-zero elements among the R^{(p)}×R^{(q)} components of A. nnz(p, q) represents the number of non-zero elements included in the R^{(p)}×R^{(p)} components. p^{(p, q)} represents mapping for converting x^{(p)} so as to correspond to column positions of non-zero elements included in A^{(q, p)} in the calculation of (Ax)^{(q)} performed by a process q. SpMV(A^{(p)}, x^{(p)}) in Equation 601 represents a matrix-vector multiplication of A^{(p)} and x^{(p)}.

As an example, a case where A is a sparse matrix of 4 rows and 4 columns as follows and y^{(p)} is calculated by using two processes of a process 0 and a process 1 will be described.

$$A = ( \begin{matrix}a & 0 & b & 0 \\ 0 & c & d & 0 \\ e & 0 & 0 & 0 \\ 0 & 0 & 0 & f\end{matrix} ) \qquad ( 2 )$$

a, b, c, d, e, and f are non-zero elements. In the case of x=(x0, x1, x2, x3)^{T}, R⁽⁰⁾={0, 1} and R⁽¹⁾={2, 3}, x⁽⁰⁾=(x0, x1)^{T} and x⁽¹⁾=(x2, x3)^{T}. R⁽⁰⁾×R⁽⁰⁾={(0, 0), (0, 1), (1, 0), (1, 1)}, and R⁽¹⁾×R⁽¹⁾={(2, 2), (2, 3), (3, 2), (3, 3)}. Accordingly, A⁽⁰⁾ and A⁽¹⁾ are a matrix of 2 rows and 2 columns as follows.

$${A}^{( 0 )} = ( \begin{matrix}a & 0 \\ 0 & c\end{matrix} ) \qquad ( 3 )$$

$${A}^{( 1 )} = ( \begin{matrix}0 & 0 \\ 0 & f\end{matrix} ) \qquad ( 4 )$$

In this case, nnz(0, 1)=2, nnz(1, 0)=1, A^{(0, 1)}=(b, d)^{T}, and A^{(1, 0)}=(e)^{T}. p^{(0, 1)}(x⁽⁰⁾)=p^{(0, 1)}((x0, x1)^{T})=(x0)^{T}, and p^{(1, 0)}(x⁽¹⁾)=p^{(1, 0)}((x2, x3)^{T})=(x2, x2)^{T}.

A process 0 transmits p^{(0, 1)}(x⁽⁰⁾)=(x0)^{T} to the process 1, and calculates y⁽⁰⁾ by the following equation.

$${y}^{( 0 )} = SpMV ( {A}^{( 0 )} , {x}^{( 0 )} ) = {( ax 0 , cx 1 )}^{T} \qquad ( 5 )$$

Next, the process 0 receives z=p^{(1, 0)}(x⁽¹⁾)=(x2, x2)^{T} from the process 1, and updates y(0) by the following equation.

$${y}^{( 0 )} = {y}^{( 0 )} + {( {A}^{( 0 , 1 )} )}^{T} z = {( ax 0 + bx 2 , cx 1 + dx 2 )}^{T} \qquad ( 6 )$$

On the other hand, the process 1 transmits p^{(1, 0)}(x⁽¹⁾)=(x2, x2)^{T} to the process 0, and calculates y⁽¹⁾ by the following equation.

$${y}^{( 1 )} = SpMV ( {A}^{( 1 )} , {x}^{( 1 )} ) = {( 0 , fx 3 )}^{T} \qquad ( 7 )$$

Next, the process 1 receives z=p^{(0, 1)}(x⁽⁰⁾)=(x0)^{T} from the process 0, and updates y⁽¹⁾ by the following equation.

$${y}^{( 1 )} = {y}^{( 1 )} + {( {A}^{( 1 , 0 )} )}^{T} z = {( ex 0 , fx 3 )}^{T} \qquad ( 8 )$$

In this case, Ax is represented by the following equation by using y⁽⁰⁾ in Equation (6) and y⁽¹⁾ in Equation (8).

$$A x = ( \begin{matrix}{y}^{( 0 )} \\ {y}^{( 1 )}\end{matrix} ) = ( \begin{matrix}ax 0 + bx 2 \\ cx 1 + dx 2 \\ ex 0 \\ fx 3\end{matrix} ) \qquad ( 9 )$$

Ax in Equation (9) matches a result obtained by calculating a matrix-vector multiplication of A and x without dividing A and x.

For the if-statement in FIG. 4, rᵢ^{(p)}=0 is used as the end condition of the for-loop. However, since rip)=0 is not satisfied in numerical calculation, for example, the following end condition is set.
(a) End condition based on number of times of solution update

i=I max
(b) End condition based on residual norm

n(rᵢ)<ε
(c) End condition based on relative residual

n(rᵢ)/n(r₀)<τ

n(rᵢ) represents an L1 norm of rᵢ, and ε represents a threshold for n(rᵢ). n(rᵢ)/n(r₀) represents a ratio of n(rᵢ) to n(r₀), and τ represents a threshold for n(rᵢ)/n(r₀). n(rᵢ) is represented by the following equation by using rᵢ^{(p)}.

n(rᵢ)=gSumMag(rᵢ^{(p)}) (10)

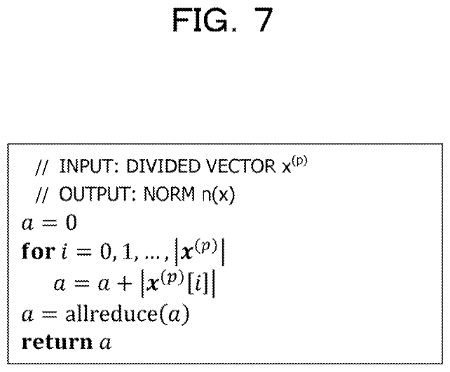

FIG. 7 illustrates an example of a pseudo code of gSumMag. A pseudo code in FIG. 7 outputs a total sum of n(x^{(p)}) as n(x). When x^{(p)} is replaced with rᵢ^{(p)}, a total sum of n(rᵢ^{(p)}) is output as n(rᵢ). In this case, a transmitted and received between the processes by allreduce(a) is an example of information on the residual for the part of the solution.

gSpMV, gSumProd, and gSumMag are names used in Open-source Field Operation and Manipulation (OpenFOAM).

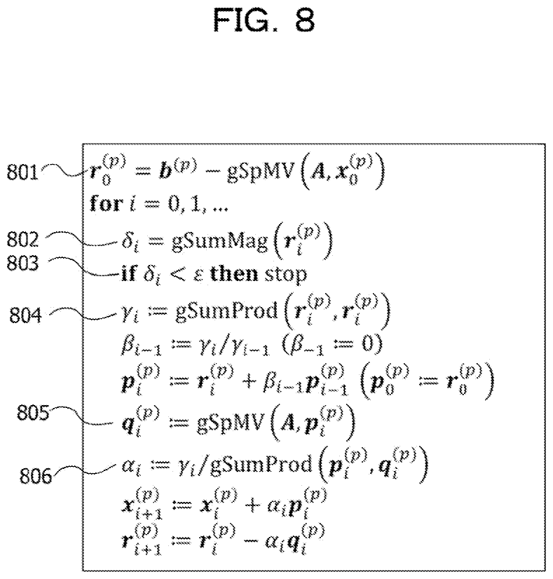

FIG. 8 illustrates an example of a second pseudo code of the parallelized CG method. A pseudo code in FIG. 8 corresponds to the pseudo code using the end condition based on the residual norm in the if-statement in FIG. 4. δᵢ in Equation 802 corresponds to n(rᵢ) in Equation (10), and δᵢ<ε in an if-statement 803 corresponds to the end condition based on the residual norm. Equation 802 and the if-statement 803 represent processing of determining an end condition for updating xᵢ^{(p)}.

At a point in time when δᵢ in Equation 802 is calculated, since x₁^{(p)} to xᵢ^{(p)} are calculated, the solution is updated i times. When the end condition of the if-statement 803 is satisfied and the update of the solution is terminated, an iterator i at this point in time represents the number of times of solution update in iterative calculation of the CG method. Since the determination of the if-statement 803 is performed before the solution is updated, the number of times of solution update may be 0.

When gSpMV in Equation 801 and Equation 805 is executed, a time taken for inter-process communication may be hidden by a calculation time of SpMV. On the other hand, when gSumMag in Equation 802 and gSumProd in Equation 804 and Equation 806 are executed, the calculation is blocked by the allreduce communication. Thus, a time taken for the allreduce communication is not hidden.

Calculation times of the matrix-vector multiplication, a vector arithmetic operation, and the like are scaled in accordance with the number of processes P, whereas the time taken for the allreduce communication is in the order of log P. Accordingly, when a large number of processes are used, the allreduce communication in the CG method is a bottleneck.

For example, in an application handling a time propagation system such as a fluid analysis simulation, loop processing using the CG method is repeatedly executed on the same coefficient matrix, and the number of times of solution update in each loop processing tends to be similar every time. Since the residual norm does not change steeply but decreases gradually in many cases, the residual norm may not to be calculated every time in each loop processing.

In this case, it is possible to reduce the number of times of calculation for the residual norm by calculating the residual norm only in the vicinity of the loop processing in which the residual norm becomes smaller than the threshold and it is predicted that the end condition is satisfied. The number of times of calculation for the residual norm is further reduced by reducing a calculation frequency itself of the residual norm in the vicinity of the loop processing. The number of times of allreduce communication in Equation 802 decreases by reducing the number of times of calculation for the residual norm, and thus, a calculation speed of each loop processing increases.

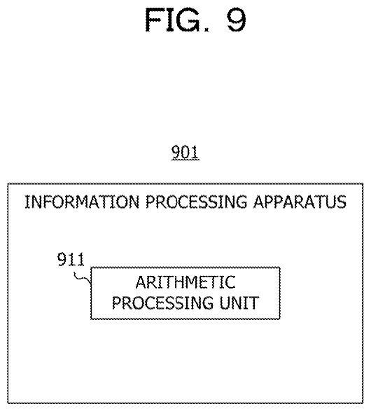

FIG. 9 illustrates a functional configuration example of an information processing apparatus (computer) according to the embodiment. An information processing apparatus 901 in FIG. 9 includes an arithmetic processing unit 911.

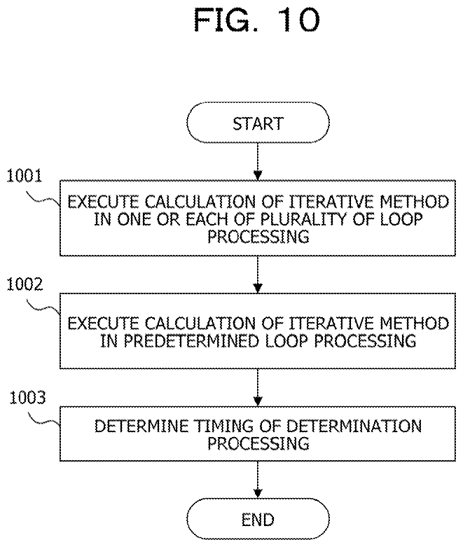

FIG. 10 is a flowchart illustrating an example of first calculation processing performed by the information processing apparatus 901 in FIG. 9. First, the arithmetic processing unit 911 executes calculation of an iterative method for iterating the update of the solution by using a plurality of processing units operating in parallel in each of one or a plurality of loop processing (step 1001). Subsequently, the arithmetic processing unit 911 executes the calculation of the iterative method by using a plurality of processing units in predetermined loop processing after the one or plurality of loop processing (step 1002).

Subsequently, based on the number of times the solution is updated in the calculation of the iterative method of each of the one or plurality of loop processing, the arithmetic processing unit 911 determines a timing of determination processing of determining the end of the update in the calculation of the iterative method of the predetermined loop processing (step 1003). The determination processing includes processing of determining whether to end the update based on a result of communication between the plurality of processing units.

According to the information processing apparatus 901 in FIG. 9, it is possible to shorten the calculation time of the iterative method using the plurality of processing units operating in parallel.

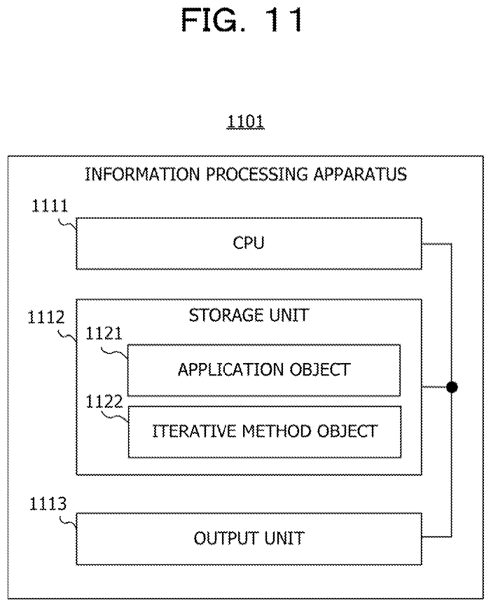

FIG. 11 illustrates a specific example of the information processing apparatus 901 in FIG. 9. An information processing apparatus 1101 in FIG. 11 includes a central processing unit (CPU) 1111, a storage unit 1112, and an output unit 1113. The CPU 1111 corresponds to the arithmetic processing unit 911 in FIG. 9.

In numerical calculation of various applications, the information processing apparatus 1101 may obtain the solution to the system of linear equations in Equation (1) by the iterative method. Examples of the application include a fluid analysis simulation, a climate simulation, and a molecular dynamics simulation in fields such as material science and biochemistry. For example, the CG method, the PCG method, the BiCG method, or the PBiCG method is used as the iterative method.

For example, the fluid analysis simulation may be a simulation in which a steady analysis of a fluid is performed by using a Pressure-Implicit with Splitting of Operators (PISO) method. In this case, the vector x in Equation (1) represents a physical quantity. The physical quantity may be a pressure or a velocity. The CG method or the PCG method may be used when x represents a pressure, and the BiCG method or the PBiCG method may be used when x represents a velocity.

The CPU 1111 includes a plurality of cores and may cause a number of processes equal to or smaller than the number of cores to operate in parallel. Each core is an arithmetic circuit, and the process is an example of the processing unit. The CPU 1111 repeats the loop processing of the application by using one or a plurality of processes at predetermined time intervals. The CPU 1111 obtains a solution x by performing the calculation of the iterative method in the loop processing of each time step. The output unit 1113 outputs the solution x obtained in each loop processing and the number of times of solution update in the loop processing.

For each process, the storage unit 1112 stores, as data used by the CPU 1111, an application object 1121 and an iterative method object 1122 for each process.

The application object 1121 includes x^{(p)}, an update history, and application data. x^{(p)} represents a vector allocated to the process p by dividing the vector x. When only a single process 0 operates, the vector x is not divided, and x^{(p)}=x⁽⁰⁾=x is satisfied. The update history represents the number of times of solution update in each executed loop processing. The number of times of solution update represents the number of times the solution xᵢ^{(p)} is updated. The update history matches between the processes. The application data represents an application-specific parameter or the like.

The iterative method object 1122 includes xᵢ^{(p)}, rᵢ^{(p)}, E, NI, NH, 1, and other pieces of iterative method data. An iterator i represents a loop variable of the for-loop in the calculation of the iterative method. xᵢ^{(p)} represents a solution to be updated in an i-th for-loop, and rᵢ^{(p)} represents a residual to be updated in the i-th for-loop. E represents a threshold for the residual norm.

NI represents a period of determination processing of determining the end of the update in the calculation of the iterative method. In the determination processing, it is determined whether or not to end the update of xᵢ^{(p)}. NH represents the number of times of solution update included in the update history. η represents a coefficient for determining a start timing at which the determination processing is started. NI and NH are integers of 1 or more, and n is a real number of 0 or more and less than 1. For example, NI, NH, and n are designated by a user. Other pieces of iterative method data include a coefficient matrix A, a vector b representing a constant term, an iterator i, and the like.

When the iterative method is the BiCG method or the PBiCG method, the iterative method object further includes a residual of a transposed version that is an update target in the i-th for-loop.

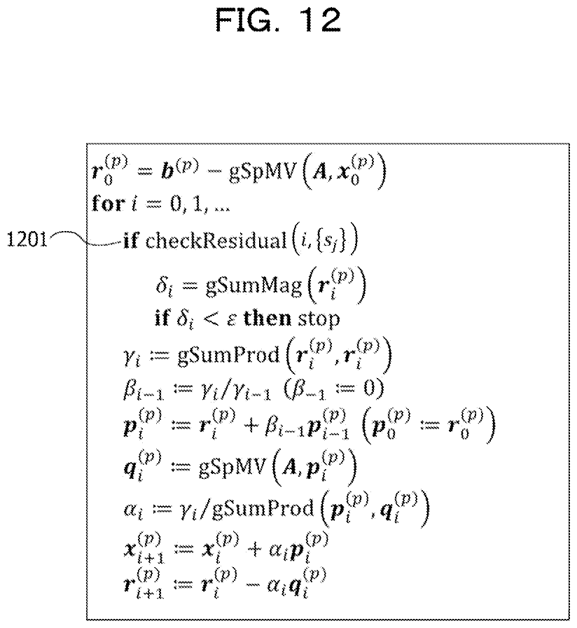

FIG. 12 illustrates an example of the pseudo code of the CG method in which the number of times of the determination processing is adjustable. A pseudo code in FIG. 12 corresponds to the pseudo code in which an if-statement 1201 is inserted before Equation 802 in FIG. 8.

checkResidual(i, {sⱼ}) of the if-statement 1201 represents a function for determining whether or not to perform the determination processing in the i-th for-loop. sⱼ represents the number of times of solution update in the loop processing before j times (j=1, 2, . . . , NH), and {sⱼ} represents an update history including s₁ to s_{NH}. checkResidual(i, {sⱼ}) is described by the following equation.

checkResidual(i,{sⱼ})=T

(i≥η min(sⱼ) and i% NI=0) (11)

checkResidual(i,{sⱼ})=F(otherwise) (12)
min(sⱼ) represents a minimum value of s₁ to s_{NH} included in {sⱼ}. The minimum value is an example of a statistical value. When the number of times of execution of the loop processing ended by one time before is less than j times, sⱼ is excluded from calculation targets of min(sⱼ). 0 is used as min(sⱼ) in first loop processing (i=0). i % NI represents a remainder when i is divided by NI.

T represents a truth value “true”, and F represents a truth value “false”. In the case of checkResidual(i, {sⱼ})=T, the determination processing is performed in the i-th for-loop, and in the case of checkResidual(i, {sⱼ})=F, the determination processing is skipped in the i-th for-loop.

In the case of η=0, η min(sⱼ)=0 is satisfied. Accordingly, checkResidual(i, {sⱼ})=T at a frequency of one time while the for-loop is executed NI times. As η is closer to 1, the determination processing may be omitted in many for-loops immediately after the start of the iterative method. However, when δᵢ becomes smaller than E faster than the prediction, there is a possibility that detection of convergence of the solution is delayed and the iteration of an unwanted for-loop is performed. In the case of η=0 and NI=1, the determination processing is performed every time in the for-loop.

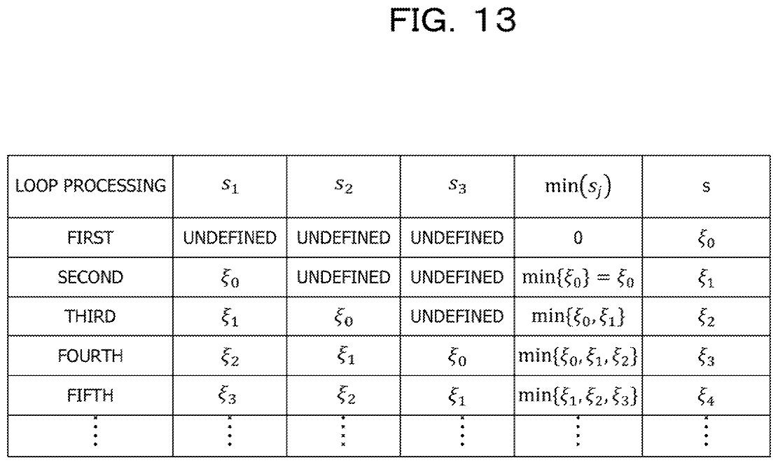

FIG. 13 illustrates an example of a change in min(sⱼ) in the case of NH=3. When sⱼ (j=1 to 3) is undefined, sⱼ is not present in the loop processing. s represents the number of times of solution update in each loop processing, and is used as s₁ in the next loop processing. In k-th loop processing, s=ξₖ₋₁ holds. Each loop processing corresponds to predetermined loop processing.

Since s₁ to s₃ are undefined in the first loop processing, min(sⱼ)=0 and s=ξ₀. Since s₂ and s₃ are undefined in second loop processing, min(sⱼ)=min{ξ₀}=ξ₀, and s=ξ₁. Since s₃ is undefined in third loop processing, min(sⱼ)=min{ξ₀, ξ₁}, and s=ξ₂.

In fourth loop processing, min(sⱼ)=min{ξ₀, ξ₁, ξ₂}, and s=ξ₃. In fifth loop processing, min(sⱼ)=min{ξ₁, ξ₂, ξ₃}, and s=ξ₄.

When a plurality of processes operate, each process basically operates independently. However, when gSpMV, gSumMag, gSumProd, or the like is executed, communication is performed between the processes, and data is exchanged.

The if-statement 1201 is executed, and thus, the CPU 1111 determines a start timing at which the determination processing is started in each loop processing based on the update history. The start timing corresponds to a for-loop in which i≥η min(sⱼ) is satisfied first in each loop processing. The start timing is determined based on the update history, and thus, it is possible to omit the determination processing in the for-loop from the start of the iterative method to the start timing of the determination processing.

On and after the start timing of the determination processing, the CPU 1111 determines the timing of the determination processing such that the determination processing is performed once while the for-loop is executed NI times. Accordingly, it is possible to reduce the number of times of the determination processing in the for-loop on and after the start timing of the determination processing.

In the determination processing, the CPU 1111 calculates δᵢ by executing gSumMag(rᵢ^{(p)}) including the allreduce communication, and determines whether or not to end the update of xᵢ^{(p)} by comparing the calculated δᵢ with E.

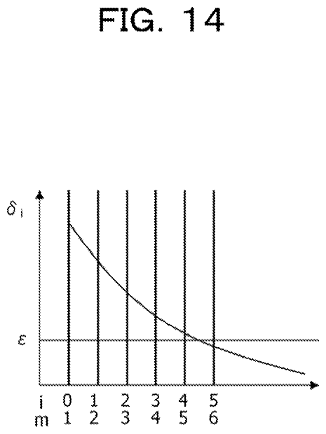

FIG. 14 illustrates an example of a first operation in the loop processing in FIG. 12. In the loop processing in FIG. 14, η=0 and NI=1. A horizontal axis represents an iterator i and a vertical axis represents δᵢ. A curve represents a change in δᵢ when it is assumed that δᵢ is calculated each time. A vertical straight line represents a timing at which δᵢ is actually calculated, and m on the horizontal axis represents the number of times δᵢ is actually calculated in zeroth to i-th for-loops.

In this case, since δᵢ is calculated every time in the zeroth to fifth for-loops and δᵢ<ε is satisfied in the fifth for-loop, the number of times of solution update is 5. The number of times of calculation for δᵢ at the end of the update is 6.

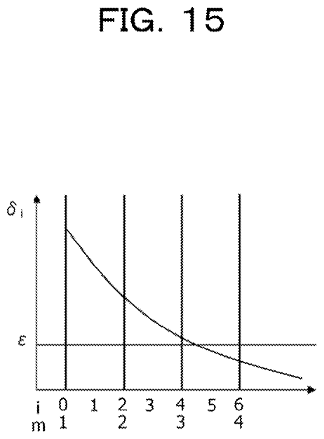

FIG. 15 illustrates an example of a second operation in the loop processing in FIG. 12. In the loop processing in FIG. 15, η=0 and NI=2, and a change in δᵢ is the same as the change in the loop processing in FIG. 14.

In this case, since δᵢ is calculated in the zeroth, second, fourth, and sixth for-loops and δᵢ<ε is satisfied in the sixth for-loop, the number of times of solution update is 6. The number of times of calculation for δᵢ at the end of the update is 4. Accordingly, the number of times of calculation for δᵢ decreases by 2 times as compared with the loop processing in FIG. 14, and the number of times of solution update increases by one time as compared with the loop processing in FIG. 14.

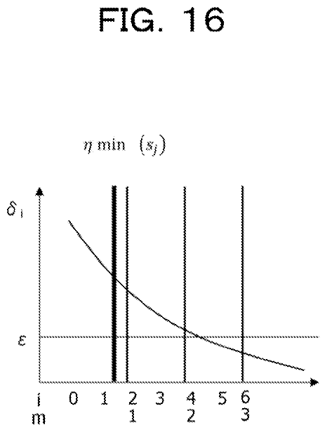

FIG. 16 illustrates an example of a third operation in the loop processing in FIG. 12. In the loop processing in FIG. 16, 0<η<1 and NI=2, and a change in δᵢ is the same as the change in the loop processing in FIG. 14.

In this case, η min(sⱼ)=1.5, and δᵢ is calculated in the second, fourth, and sixth for-loops. Since δᵢ<ε is satisfied in the sixth for-loop, the number of times of solution update is 6. The number of times of calculation for δᵢ at the end of the update is 3. Accordingly, the number of times of calculation for δᵢ decreases by 3 times as compared with the loop processing in FIG. 14, and the number of times of solution update increases by one time as compared with the loop processing in FIG. 14.

As described above, a reduction in the number of times of calculation for δᵢ and an increase in the number of times of solution update are in a trade-off relationship. It is possible to effectively reduce the number of times of calculation for δᵢ while the unwanted update of the solution is suppressed by adjusting η and NI to appropriate values.

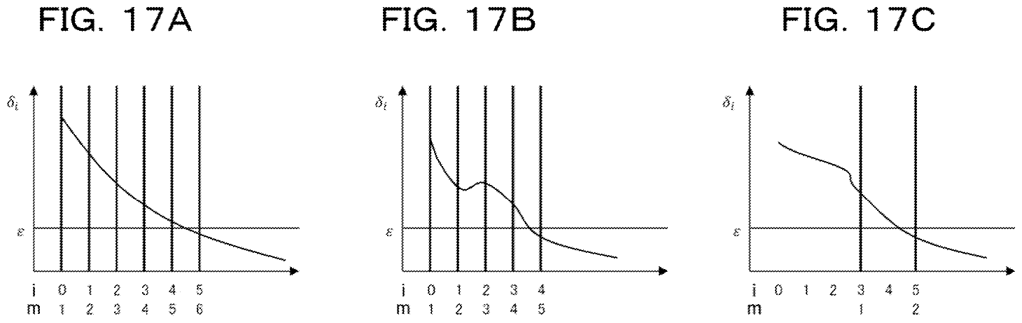

FIGS. 17A to 17C illustrate examples of the number of times of calculation for the residual norm in the loop processing in a plurality of time steps. FIG. 17A illustrates an example of an operation in the first loop processing. In this case, since δᵢ is calculated every time in the zeroth to fifth for-loops and δᵢ<E is satisfied in the fifth for-loop, the number of times of solution update is 5. The number of times of calculation for δᵢ at the end of the update is 6.

FIG. 17B illustrates an example of an operation in the second loop processing. In this case, since δᵢ is calculated every time in the zeroth to fourth for-loops and δᵢ<ε is satisfied in the fourth for-loop, the number of times of solution update is 4. The number of times of calculation for δᵢ at the end of the update is 5.

FIG. 17C illustrates an example of an operation in the third loop processing. In this case, since δᵢ is calculated in the third and fifth for-loops and δᵢ<ε is satisfied in the fifth for-loop, the number of times of solution update is 5. The number of times of calculation for δᵢ at the end of the update is 2. Accordingly, the number of times of calculation for δᵢ is smaller than the number of times of solution update by 3 times.

According to the pseudo code in FIG. 12, since the calculation of the residual norm is performed only in the determination processing, the calculation of the residual norm does not affect the calculation for updating the solution and the residual. Accordingly, as illustrated in FIGS. 15 and 16, the number of times of solution update may increase by skipping the determination processing, therefore, the convergence of the solution does not degrade. When the reduced inter-process communication is longer than the update time of the solution increased by skipping the determination processing, the calculation time of the entire processing of obtaining the solution of the system of linear equations is shortened.

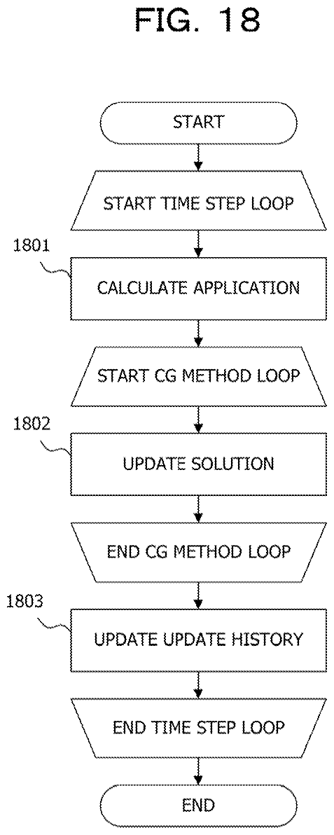

FIG. 18 is a flowchart illustrating an example of second calculation processing performed by the information processing apparatus 1101 in FIG. 11. The CPU 1111 executes an application program to perform the calculation processing in FIG. 18 by using the application object 1121 and the iterative method object 1122. The calculation processing corresponds to a fluid analysis simulation, a climate simulation, a molecular dynamics simulation, or the like.

The CPU 1111 repeats the loop processing of a time step loop of step 1801 to step 1803. In the loop processing of the time step loop, the CPU 1111 performs the calculation of the application by using the application object 1121 (step 1801). For example, the calculation of the application corresponds to the calculation that does not use the CG method among the calculations for obtaining the physical quantity.

Subsequently, the CPU 1111 repeats processing of a CG method loop in step 1802. The processing of the CG method loop corresponds to processing of the for-loop in the pseudo code in FIG. 12, and the CPU 1111 causes each process p to execute the processing of the for-loop. In the processing of the CG method loop, the CPU 1111 updates x^{(p)} for each process p to update the solution x by using the iterative method object 1122 (step 1802). The processing of the CG method loop is repeated until the residual norm satisfies the end condition.

After the repetition of the processing of the CG method loop ends, the CPU 1111 updates the update history included in the application object 1121 (step 1803). The output unit 1113 outputs the obtained solution and the number of times of solution update. The processing of the time step loop is repeated until the time reaches a last time step in the calculation processing.

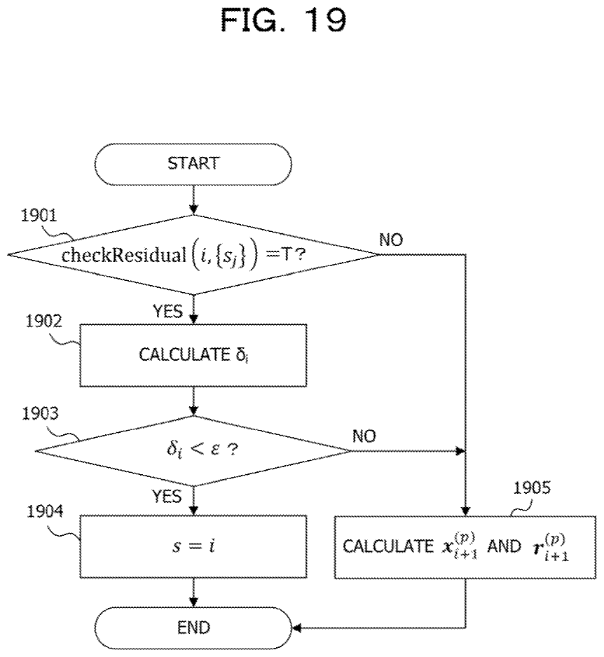

FIG. 19 is a flowchart illustrating an example of solution update processing in step 1802 in FIG. 18. The solution update processing in FIG. 19 is performed for each process p.

First, the CPU 1111 checks whether or not checkResidual(i, {sⱼ}) is T (step 1901). When checkResidual(i, {sⱼ}) is F (NO in step 1901), the CPU 1111 updates xᵢ^{(p)} and rᵢ^{(p)} and calculates xᵢ^{(p)} and rᵢ₊₁^{(p)} (step 1905). The CPU 1111 increments i by 1 and performs the processing of the next for-loop.

On the other hand, when checkResidual (i, {sⱼ}) is T (YES in step 1901), the CPU 1111 calculates δᵢ (step 1902) and compares the calculated bi with E (step 1903).

When δᵢ is equal to or greater than E (NO in step 1903), the CPU 1111 performs the processing of step 1905. The CPU 1111 increments i by 1 and performs the processing of the next for-loop. On the other hand, when δᵢ is smaller than ε (YES in step 1903), the CPU 1111 sets the iterator i at this time to the number of times of solution update s (step 1904) and ends the processing of the for-loop.

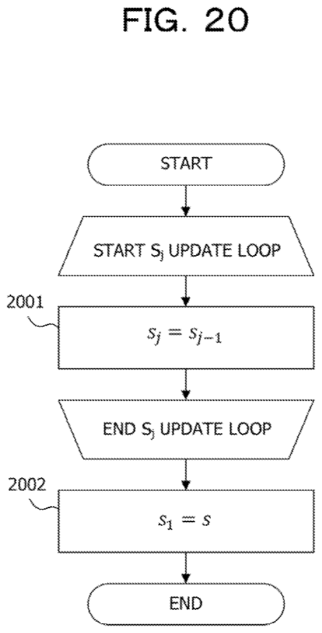

FIG. 20 is a flowchart illustrating an example of the history update processing in step 1803 in FIG. 18. First, the CPU 1111 repeats the processing of a sⱼ update loop in step 2001 in descending order of j for j=NI to 2. In the processing of the sⱼ update loop, the CPU 1111 overwrites sⱼ with a value of sⱼ₋₁ included in the update history {sⱼ} (step 2001).

After the repetition of the processing of the sⱼ update loop is ended, the CPU 1111 overwrites s₁ with a value of s set in step 1904 (step 2002).

As an example, an example of the solution update processing performed in the loop processing in a certain time step when A is a sparse matrix of 4 rows and 4 columns as follows will be described.

$$A = ( \begin{matrix}1 & 0.1 & 0 & 0 \\ 0 & 1 & 0 & 0 \\ 0 & 0 & 1 & 0 \\ 0 & 0 & 0.1 & 1\end{matrix} ) \qquad ( 13 )$$

When b=(1, 2, 3, 4)^{T} and x₀=(1, 3, 5, −3)^{T}, an exact solution is x=(0.8, 2, 3, 3.7)^{T}. When the solution x of the system of equations is calculated by using two processes of the process 0 and the process 1, two-dimensional vectors are used as xᵢ⁽⁰⁾ and xᵢ⁽¹⁾.

When ε=10⁻⁵, NI=2, NH=2, η=0.5, s₁=₃, and s₂=4, η min(sⱼ) is calculated by the following equation.

η min(sⱼ)=0.5 min{3,4}=1.5 (14)

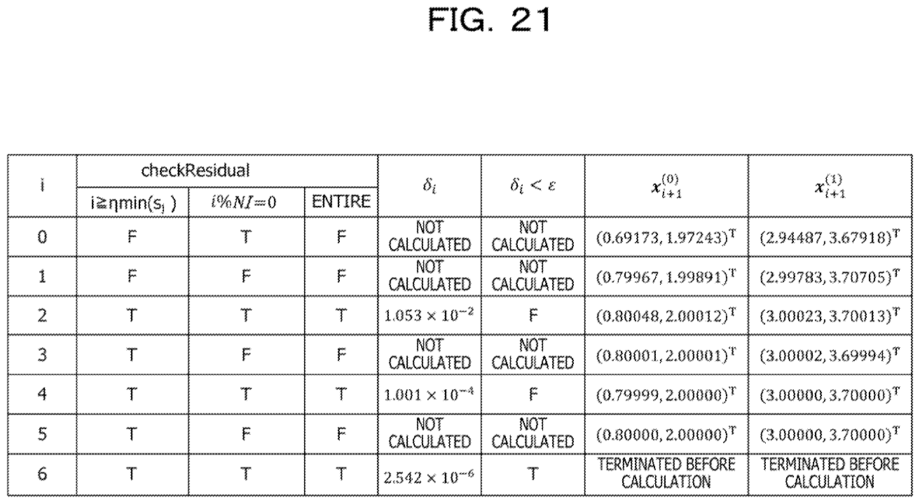

FIG. 21 illustrates an example of the solution update processing in this case. The entire checkResidual represents a value of checkResidual(i, {sⱼ}), and δ₁<ε represents a determination result of the end condition. “Not calculated” for δᵢ and δᵢ<ε means that the determination processing is skipped.

δᵢ is calculated by a double-precision floating-point format, and is indicated up to a third decimal place by an exponent display. xᵢ₊₁⁽⁰⁾ and xᵢ₊₁⁽¹⁾ are calculated in the double-precision floating-point format, and are displayed up to a fifth decimal place.

In the for-loop of i=0, a truth value of i≥η min(sⱼ) in Equation (11) is F, and a truth value of i % NI=0 is T. Accordingly, since the entire truth value is F, the determination processing is skipped. x₁⁽⁰⁾ is calculated by the process 0, and x₁⁽¹⁾ is calculated by the process 1.

In the for-loop of i=1, a truth value of i≥η min(sⱼ) and i % NI=0 is F. Accordingly, since the entire truth value is F, the determination processing is skipped. x₂⁽⁰⁾ is calculated by the process 0, and x₂⁽¹⁾ is calculated by the process 1.

In the for-loop of i=2, a truth value of i≥η min(sⱼ) and i % NI=0 is T. Accordingly, since the entire truth value is T, the determination processing is performed. In this case, since the determination result of δᵢ<ε is F, the solution update processing is continued. x₃⁽⁰⁾ is calculated by the process 0, and x₃⁽¹⁾ is calculated by the process 1.

In the for-loop of i=3, a truth value of i≥η min(sⱼ) is T, and a truth value of i % NI=0 is F. Accordingly, since the entire truth value is F, the determination processing is skipped. x₄⁽⁰⁾ is calculated by the process 0, and x₄⁽¹⁾ is calculated by the process 1.

In the for-loop of i=4, a truth value of i≥η min(sⱼ) and i % NI=0 is T. Accordingly, since the entire truth value is T, the determination processing is performed. In this case, since the determination result of δᵢ<ε is F, the solution update processing is continued. x₅⁽⁰⁾ is calculated by the process 0, and x₅⁽¹⁾ is calculated by the process 1.

In the for-loop of i=5, a truth value of i≥η min(sⱼ) is T, and a truth value of i % NI=0 is F. Accordingly, since the entire truth value is F, the determination processing is skipped. x₆⁽⁰⁾ is calculated by the process 0, and x₆⁽¹⁾ is calculated by the process 1.

In the for-loop of i=6, a truth value of i≥η min(sⱼ) and i % NI=0 is T. Accordingly, since the entire truth value is T, the determination processing is performed. In this case, since the determination result of δᵢ<ε is T, the solution update processing is terminated. Accordingly, x₇⁽⁰⁾ and x₇⁽¹⁾ are not calculated. The output unit 1113 outputs x₆⁽⁰⁾ and x₆⁽¹⁾ as solutions, and outputs s=6 as the number of times of solution update.

Although the end condition based on the residual norm is used in the pseudo code in FIG. 12, the end condition may be an end condition based on the number of times of solution update or the relative residual, or may be a combination of a plurality of end conditions. The combination of the plurality of end conditions may be a logical disjunction of the plurality of end conditions.

For example, when the end condition based on the relative residual is used, the CPU 1111 calculates n(r₀)=gSumMag(r₀^{(p)}) at the start of the CG method loop, and checks whether or not δᵢ/n(r₀)<τ is satisfied in the determination processing.

When the PCG method, the BiCG method, or the PBiCG method is used instead of the CG method, it is also possible to shorten the calculation time of the processing of obtaining the solution of the system of linear equations by reducing the number of times of the determination processing in the same manner.

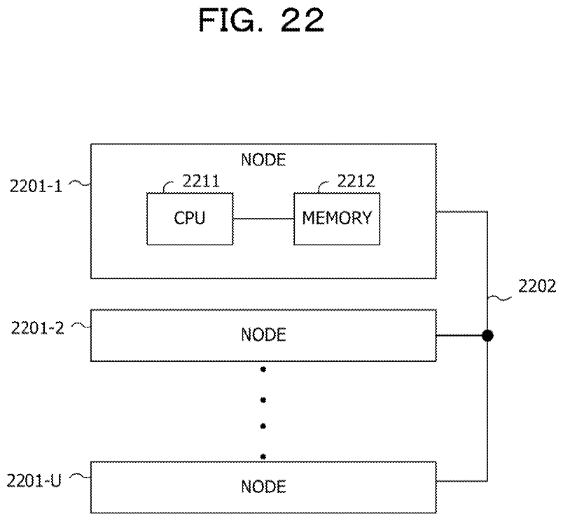

FIG. 22 illustrates a hardware configuration example of an information processing apparatus including a plurality of nodes. The information processing apparatus in FIG. 22 includes a node 2201-1 to a node 2201-U (U is an integer of 2 or more). Each node 2201-u (u=1 to U) includes a CPU 2211 and a memory 2212. The CPU 2211 and the memory 2212 are hardware. The CPU 2211 corresponds to the arithmetic processing unit 911 in FIG. 9.

As in the CPU 1111 in FIG. 11, the CPU 2211 may cause a plurality of processes to operate in parallel. The memory 2212 stores the same information as the information in FIG. 11.

The node 2201-1 to the node 2201-U may communicate with each other via a communication network 2202. For example, the communication network 2202 is an interconnect according to a standard such as Ethernet (registered trademark), InfiniBand, or Tofu interconnect. A coupling method of the communication network 2202 may be a mesh, a torus, or a fat tree. Communication between the processes operating in two nodes 2201-u, respectively, is performed via the communication network 2202.

As in the information processing apparatus 1101 in FIG. 11, the information processing apparatus in FIG. 22 performs calculation processing by using a plurality of processes operating in the node 2201-1 to the node 2201-U.

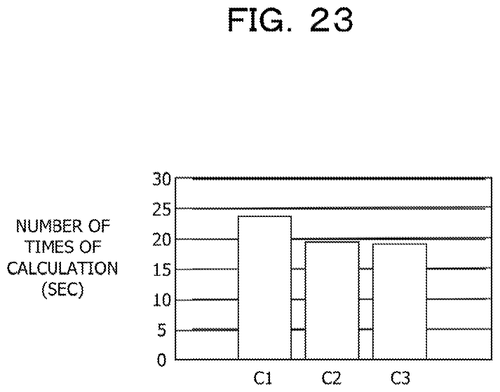

FIG. 23 illustrates an example of a calculation time in a fluid analysis simulation for calculating a physical quantity of a 100×100×100 structured mesh. In this example, a test case called a cavity of OpenFOAM HPC Benchmark suite is used, and 40 processes are operated in each of 32 nodes. Accordingly, the total number of processes is 1280. ε is 10⁻⁴.

C1 represents a simulation result when η=0 and NI=1. C2 represents a simulation result when η=0 and NI=10. C3 represents a simulation result when η=0.5, NI=10, and NH=10. Calculation times of C2 and C3 are shorter than a calculation time of C1, and the calculation processing of C3 is speeded up by about 1.24 times as compared with the calculation processing of C1.

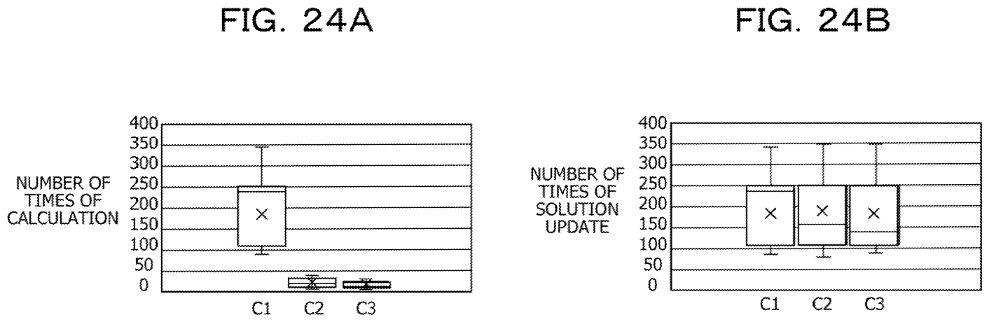

FIGS. 24A and 24B illustrate examples of the number of times of calculation for δᵢ and the number of times of solution update in the fluid analysis simulation in FIG. 23.

FIG. 24A illustrates an example of the number of times of calculation for δᵢ is calculated for each loop processing in each time step. In a box-and-whisker plot of each of C1 to C3, a × mark in a box indicates an average value of the number of times of calculation, and a horizontal line in the box indicates a median value of the number of times of calculation. A lower end of the box indicates a first quartile of the number of times of calculation, an upper end of the box indicates a third quartile of the number of times of calculation, a lower end of the whisker indicates a minimum value of the number of times of calculation, and an upper end of the whisker indicates a maximum value of the number of times of calculation. The number of times of calculation for C2 and C3 is significantly smaller than the number of times of calculation for C1.

FIG. 24B illustrates an example of the number of times of solution update for each loop processing in each time step. In a box-and-whisker plot of each of C1 to C3, a × mark in a box indicates an average value of the number of times of solution update, and a horizontal line in the box indicates a median value of the number of times of solution update. A lower end of the box indicates a first quartile of the number of times of solution update, an upper end of the box indicates a third quartile of the number of times of solution update, a lower end of the whisker indicates a minimum value of the number of times of solution update, and an upper end of the whisker indicates a maximum value of the number of times of solution update. The number of times of solution update for C2 and C3 is approximately the same as the number of times of solution update for C1.

The configurations of the information processing apparatus 901 in FIG. 9, the information processing apparatus 1101 in FIG. 11, and the information processing apparatus in FIG. 22 are merely examples, and some of constituent elements may be omitted or modified in accordance with an application or a condition of the information processing apparatus. For example, parallel processing may be executed by using an accelerator such as a graphics processing unit (GPU) instead of the CPU. In this case, another processing unit such as a thread may be used instead of the process.

The flowcharts in FIGS. 10 and 18 to 20 are merely examples, and some of the processing may be omitted or changed in accordance with the configuration or conditions of the information processing apparatus.

The pseudo codes illustrated in FIGS. 1 to 8 and 12 are merely examples, and the algorithm of the iterative method may be described in another format. min(sⱼ) illustrated in FIG. 13 is merely an example, and min(sⱼ) changes in accordance with NH. An operation of the loop processing illustrated in FIGS. 14 to 17C is merely an example, and the operation of the loop processing changes in accordance with η, NH, and NI.

The solution update processing illustrated in FIG. 21 is merely an example, and the solution update processing varies in accordance with η, NH, and NI. A simulation result illustrated in FIGS. 24A and 24B is merely an example, and the simulation result changes in accordance with the system of equations used in the simulation.

Equations (1) to (14) are merely examples, and the information processing apparatus may perform calculation processing by using another calculation equation. For example, another statistical value such as an average value, a median value, a mode value, or a maximum value of s₁ to s_{NH} may be used instead of min(sⱼ) in Equation (11).

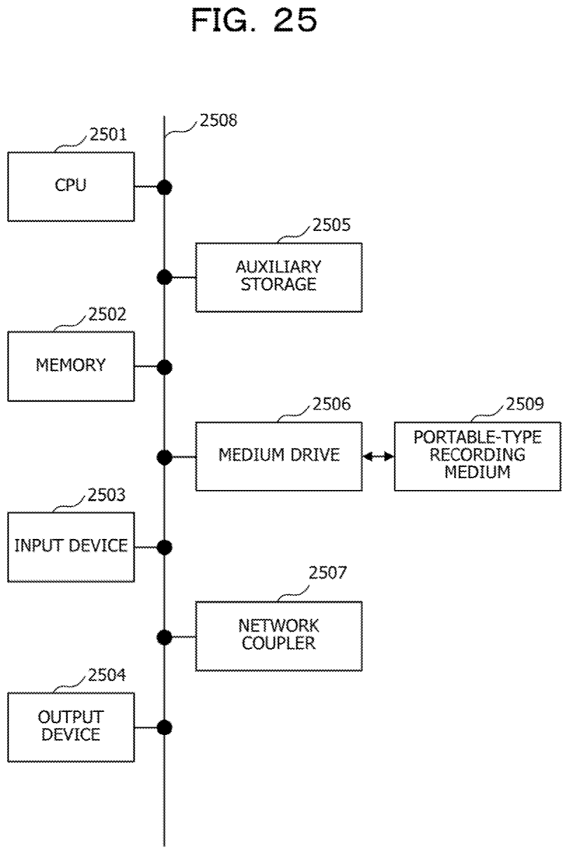

FIG. 25 illustrates a hardware configuration example of the information processing apparatus 901 in FIG. 9 and the information processing apparatus 1101 in FIG. 11. The information processing apparatus in FIG. 25 includes a CPU 2501, a memory 2502, an input device 2503, an output device 2504, an auxiliary storage 2505, a medium drive 2506, and a network coupler 2507. These constituent elements are hardware, and are coupled to each other via a bus 2508.

The memory 2502 is, for example, a semiconductor memory such as a read-only memory (ROM) or a random-access memory (RAM), and stores a program and data used for processing. The memory 2502 may operate as the storage unit 1112 in FIG. 11.

For example, the CPU 2501 executes a program by using the memory 2502 to operate as the arithmetic processing unit 911 in FIG. 9. The CPU 2501 also operates as the CPU 1111 in FIG. 11. The CPU 2501 is also referred to as a processor in some cases.

The input device 2503 is, for example, a keyboard, a pointing device, or the like, and is used to input an instruction or information from a user or operator. The output device 2504 is, for example, a display device, a printer or the like, and is used to output an inquiry or instruction and a processing result to the user or operator. A processing result may be a calculation result including a solution for each time step. The output device 2504 may also operate as the output unit 1113 in FIG. 11.

The auxiliary storage 2505 is, for example, a magnetic disk drive, an optical disk drive, a magneto-optical disk drive, a tape drive, or the like. The auxiliary storage 2505 may be a hard disk drive or a solid-state drive (SSD). The information processing apparatus stores the programs and data in the auxiliary storage 2505 and may use the programs and data by loading the programs and data into the memory 2502. The auxiliary storage 2505 may operate as the storage unit 1112 in FIG. 11.

The medium drive 2506 drives a portable-type recording medium 2509 and accesses data recorded therein. The portable-type recording medium 2509 is a memory device, a flexible disk, an optical disk, a magneto-optical disk, or the like. The portable-type recording medium 2509 may be a compact disk read-only memory (CD-ROM), a Digital Versatile Disk (DVD), a Universal Serial Bus (USB) memory, or the like. The user or operator may store a program and data in the portable-type recording medium 2509, and load these programs and data into the memory 2502 for use.

As described above, a computer readable recording medium storing the programs and data used for processing is a physical (non-transitory) recording medium, such as the memory 2502, the auxiliary storage 2505, or the portable-type recording medium 2509.

The network coupler 2507 is a communication interface circuit coupled to a communication network such as a local area network (LAN) or a wide area network (WAN) to perform data conversion associated with communication. The information processing apparatus may receive the programs and data from an external apparatus via the network coupler 2507 and load these programs and data into the memory 2502 for use. The network coupler 2507 may operate as the output unit 1113 in FIG. 11.

The information processing apparatus does not have to include all the constituent elements in FIG. 25, and some of the constituent elements may be omitted in accordance with the use or conditions of the information processing apparatus. For example, when an interface to the user or operator is not to be used, the input device 2503 and the output device 2504 may be omitted. When the portable-type recording medium 2509 or the communication network is not used, the medium drive 2506 or the network coupler 2507 may be omitted.

Although the disclosed embodiment and its advantages have been described in detail, those skilled in the art could make various modifications, additions, and omissions without deviating from the scope of the present disclosure clearly recited in claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a calculation program for causing a computer to execute a process comprising:
executing calculation of an iterative method for iterating update of a solution by using a plurality of processing circuits operating in parallel in one or each of a plurality of loop processing;
executing the calculation of the iterative method by using the plurality of processing circuits in predetermined loop processing after the one or plurality of loop processing; and
determining a timing of determination processing of determining update end in the calculation of the iterative method of the predetermined loop processing based on a number of times the solution is updated in the calculation of the iterative method of the one or each of the plurality of loop processing,
wherein the determination processing includes processing of determining the update end based on a result of communication between the plurality of processing circuits.

2. The non-transitory computer-readable recording medium according to claim 1,
wherein the processing of determining the timing of the determination processing includes
processing of determining a start timing of starting the determination processing in the calculation of the iterative method of the predetermined loop processing based on a statistical value of the number of times the solution is updated in the calculation of the iterative method in the one or each of the plurality of loop processing.

3. The non-transitory computer-readable recording medium according to claim 1,
wherein the processing of determining the timing of the determination processing includes
processing of determining a timing of the determination processing such that the determination processing is performed once while the update of the solution is performed multiple times in the calculation of the iterative method of the predetermined loop processing.

4. The non-transitory computer-readable recording medium according to claim 1,
wherein the calculation of the iterative method is calculation of obtaining a solution of a system of linear equations,
processing of calculating a part of the solution of the system of linear equations is allocated to each of the plurality of processing circuits, and
the processing of determining the update end based on the result of the communication includes
processing of transmitting and receiving information on a residual for the part of the solution of the system of linear equations between the plurality of processing circuits,
processing of obtaining a residual for the solution of the system of linear equations by using the information on the residual for the part of the solution of the system of linear equations, and
processing of determining whether or not to end the update of the solution based on the residual for the solution of the system of linear equations.

5. A calculation method comprising:
executing calculation of an iterative method for iterating update of a solution by using a plurality of processing circuits operating in parallel in one or each of a plurality of loop processing;
executing the calculation of the iterative method by using the plurality of processing circuits in predetermined loop processing after the one or plurality of loop processing; and
determining a timing of determination processing of determining update end in the calculation of the iterative method of the predetermined loop processing based on a number of times the solution is updated in the calculation of the iterative method of the one or each of the plurality of loop processing,
wherein the determination processing includes processing of determining the update end based on a result of communication between the plurality of processing circuits.

6. The calculation method according to claim 5,
wherein the processing of determining the timing of the determination processing includes
processing of determining a start timing of starting the determination processing in the calculation of the iterative method of the predetermined loop processing based on a statistical value of the number of times the solution is updated in the calculation of the iterative method in the one or each of the plurality of loop processing.

7. The calculation method according to claim 5,
wherein the processing of determining the timing of the determination processing includes
processing of determining a timing of the determination processing such that the determination processing is performed once while the update of the solution is performed multiple times in the calculation of the iterative method of the predetermined loop processing.

8. The calculation method according to claim 5,
wherein the calculation of the iterative method is calculation of obtaining a solution of a system of linear equations,
processing of calculating a part of the solution of the system of linear equations is allocated to each of the plurality of processing circuits, and
the processing of determining the update end based on the result of the communication includes
processing of transmitting and receiving information on a residual for the part of the solution of the system of linear equations between the plurality of processing circuits,
processing of obtaining a residual for the solution of the system of linear equations by using the information on the residual for the part of the solution of the system of linear equations, and
processing of determining whether or not to end the update of the solution based on the residual for the solution of the system of linear equations.
